(19) United States
(12) Patent Application Publication
(10) Pub. No.: US 2005/0224596 A1
(43) Pub. Date: Oct. 13, 2005

(54) Machine that is an automatic pesticide, insecticide, repellant, poison, air freshener, disinfectant or other type of spray delivery system

(76) Inventor: Peter John Panopoulos, Hickory Hills, IL (US)

Correspondence Address: PETER J. PANOPOULOS, 9220 S. 87TH COURT, HICKERY HILLS, IL, 60457, US

(21) Appl. No.: 10/885,187

(22) Filed: Jul. 6, 2004

Related U.S. Application Data
(60) Provisional application No. 60/485,548, filed on Jul. 8, 2003.

(51) Int. Cl. B05B 17/04; A01G 27/00; B05B 3/00

(52) U.S. Cl. 239/67; 239/722; 239/68

(57) ABSTRACT

Automatic pesticide, insecticide, repellant, poison, air freshener, disinfectant or other spray-type delivery systems are proposed for automating the delivery of these items to areas, for controlling pests easier, for improving environmental conditions, and for making it easier to freshen the air and to disinfect areas. The device includes a logic circuit and mechanisms containing a circuit that will enable a user to program the device to discharge a spray of its poison, disinfecting or air freshening spray(s) at a pre-selected time interval or day/time interval chosen in the unit's memory. An electromechanical valve opens to let contents escape when the spraying mechanism of the system is activated. The valve connects to a pressurized spray cylinder and it releases a controlled burst of insecticide, pesticide, repellant, disinfectant, and or air freshener as programmed. Control circuits allow the user to set when the system goes off.

### CROSS REFERENCE TO RELATED APPLICATIONS

This application is based on provisional application Ser. No. 60/485,548, filed on Jul. 7, 2003.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

1. Field of the Invention

The present invention relates generally to a spray delivery system and more specifically it relates to automatic pesticide, insecticide, repellant, poison, air freshener, disinfectant delivery system for automating the delivery of pesticides, insecticides, repellants, air fresheners and disinfectants or other sprayable items whether from liquid gas or powder form from compressed cylinders for making the control of pests much more convenient, effective, productive, and deadly; and for improving environmental conditions, or for other various uses too numerous to mention as there are liquids, gasses and powders for many uses.

2. Description of the Related Art

It can be appreciated that pesticides, insecticides, and repellants, air fresheners and disinfectants have been in use for years. Typically, pesticides, insecticides, repellants, air fresheners, and disinfectants are found in aerosol spray cans, squirt bottles or in other types of commercial variants where pesticides, insecticides, repellants, air fresheners and or disinfectants have to be purchased whereby the consumer has to manually spray the pesticides or the air fresheners or disinfectants in the area desired, or directly on the insects to be killed, or where the consumer or the commercial buyer mixes poisons, air fresheners, or other sprayable items and applies them to desired areas through a manual spraying system by hand.

The main problems with conventional pesticide, insecticide, repellant, air freshener, and disinfectant delivery systems are that they are cumbersome to use and that they are manual, time-consuming systems to control pests and insects. Another problem with conventional pesticide, insecticide, and repellant, air freshener, and disinfectant delivery systems are that the spray cans for every day pesticides, insecticides and repellants, pesticides, air fresheners, disinfectants, and other sprayable items used for gardens, for farming, for commercial use and for other applications, including the killing of flies, ants, spiders, roaches, mosquitoes, rodents, other pests, and or to spray other sprayable items for other applications whereby such items are generally not refillable.

Another problem with existing products is that they do not automatically seal off areas of your house or apartment or zone off areas in your garden, on your patio, or in commercial areas, and keep them sprayed in an unattended fashion automatically to alleviate pest problems while you are away.

Another problem with existing products is that they are not designed to create boundaries of pesticide by spraying in line squirts, in area squirts, and in fog squirts, to accommodate window sills, doorways, hallways, and outdoor areas, as the custom designed pesticide delivery units in our design allow you to cover areas where pests may break through where they normally enter homes and apartments.

Another problem with existing products is that they are not programmable to automatically deliver pesticide at precisely timed day/time intervals, or at certain timed moments for a broad spectrum of insecticides, repellants, and or pesticides covering all pesticides and repellants containing toxic and non-toxic repellants and pesticides, for insects, rodents, wildlife and all pests.

Another problem with conventional pesticide delivery system are that there is not an easy convenient method in place where a consumer can buy a large economical charging tank of pesticide, repellant or insecticide and where a consumer or a commercial user can refill the automatic pesticide delivery units of varying size and insert the refillable tanks into their control units for operation wherever they are to be used.

While these devices may be suitable for the particular purpose to which they address, they are not as suitable for automating the delivery of pesticides, insecticides, and repellants and for making the control of pests much more convenient, efficient, productive, and deadly. The main problem with conventional pesticide delivery system are that they are cumbersome to use and that they are manual, time-consuming systems to control pests and insects and rodents.

Another problem is that the spray cans for every day pesticides, and pesticides used for gardens, for farming, for commercial use and for other applications, including the killing of flies, ants, spiders, roaches, mosquitoes, rodents, and other pests, are generally not refillable.

Another problem with existing products is that they do not automatically seal off areas of your house or apartment or zone off areas in your garden, on your patio, or in commercial areas, and keep them sprayed in an unattended fashion automatically to alleviate pest problems while you are away.

Another problem with existing products is that they are not designed to create boundaries of pesticide by spraying in line squirts, in area squirts, and in fog squirts, to accommodate window sills, doorways, hallways, and outdoor areas, as the custom designed pesticide delivery units in our design allow you to cover areas where pests may break through where they normally enter homes and apartments.

Another problem with existing products is that they are not programmable to automatically deliver pesticide at precisely timed day/time intervals, or at certain timed moments for a broad spectrum of insecticides, repellants, and or pesticides covering all pesticides and repellants containing toxic and non-toxic repellants and pesticides, for insects, rodents, wildlife and all pests.

Another problem of existing systems is that they do not allow a user to program the system through manual means on a control panel on the spray delivery system or to program a plurality of spray delivery systems through wired or wireless means through a wireless remote or through a computer whereby each spray delivery system has a unique identification code and whereby a user may view all programmed information for each spray delivery system and to view how much is left in each cylinder at any point in time and to alter and change programmed parameters as to how to deliver sprayable items through automated means as in the present invention.

Also, another problem is that there is not an easy convenient method in place where a consumer can buy a large economical charging tank of pesticide, repellant or insecticide and where a consumer or a commercial user can refill the automatic pesticide delivery units of varying size and insert the refillable tanks into their control units for operation wherever they are to be used.

In these respects, the automatic pesticide, insecticide, repellant, poison, air freshener, disinfectant delivery systems according to the present invention substantially departs from the conventional concepts and designs of the prior art, and in so doing provides an apparatus primarily developed for the purpose of automating the delivery of pesticides, insecticides, and repellants and for making the control of pests much more convenient, efficient, productive, and deadly.

In view of the foregoing disadvantages inherent in the known types of pesticides, insecticides, and repellants now present in the prior art, the present invention provides a new automatic spray delivery system construction wherein the same can be utilized for automating the delivery of pesticides, insecticides, and repellants and for making the control of pests much more convenient, effective, productive, and deadly.

The general purpose of the present invention, which will be described subsequently in greater detail, is to provide a new automatic pesticide-insecticide-repellant-poison delivery system that has many of the advantages of the pesticide, insecticide, and repellant delivery systems mentioned heretofore and many novel features that result in new automatic pesticide-insecticide-repellant-poison delivery systems which is not anticipated, rendered obvious, suggested, or even implied by any of the prior art pesticide delivery system, either alone or in any combination thereof.

To attain this, the present invention generally comprises logic circuits containing a circuit that will enable a user to program the pesticide-insecticide-repellant delivery system to discharge a spray of its poison at a pre-selected time interval or day/time interval chosen in the unit's memory. Another component of the invention includes a logic circuit that will warn the user when the cylinder is low on poison through a pressure transducer when the system is low on poison. Another component of the invention includes an electromechanical valve that opens to let the poison escape when the automated spraying mechanism of the pesticide, insecticide, repellant, air freshener, or spray delivery system is activated.

The spray cylinder component of the invention contains the pressurized insecticides, pesticides, repellants, air fresheners, or other sprayable substances used by the automated spray system. The electromechanical valve of the invention connects to the pressurized spray cylinder and when activated releases a controlled burst (which is settable) of insecticide, pesticide, repellant, air freshener, or other sprayable substance(s) when programmed to do so by the control circuits of the automatic pesticide, insecticide, repellant, poison, air-freshener, or other sprayable substance delivery system. The control circuits of the invention allow the user to set how often the automatic spray system discharges a spray burst from the cylinder to activate the electromechanical valve to release a controlled burst of the cylinder contents.

They also tell the consumer how full the cylinder is and if the cylinder is low on gas, powder, or liquid, or other sprayable contents so the consumer or the commercial user can recharge the cylinders or purchase new ones with more liquid insecticides, pesticides, or repellants, air fresheners, or other sprayable contents, or purchase entire new systems. The spray nozzles allow the pesticides, insecticides, and or repellants to be directed as desired for spraying purposes and can be adjusted by the consumer to spray as desired with adjustable nozzles to spray in a number of ways or be fitted in manufacturing to spray in a finite number of ways: (i.e., tight line spraying, mist spraying, straight-line squirting, mist spray, 30 degree, 45 degree, 60 degree, 90 degree, 180 degree, 360 degree, or other degree settings, or to use special nozzles where the nozzles themselves can vary the spray degree angle, etc.). It is also envisioned that there can be left-handed and right-handed models made and other models where the models are made with multiple spray jets to spray to the left, to the right, up, down, back, forward, etc., and some right where the unit is placed to get everything. The units can also spray in front and in behind of the units. Thus various spraying arrangements can be developed and marketed. Extended tubes can deliver a pesticide or repellant spray in an automated fashion by spraying it through an extended tube to another area where the spraying canister system is placed in one area and the tube is extended a certain distance “X” away from the spraying canister system where the tube will be mounted to an area where it will eventually spray at; and where the tube will have an end where the actual spray may flow in either a tight line spray, a mist spray, a straight-line squirting, a mist spray, a 30 degree, a 45 degree, a 60 degree, a 90 degree, a 180 degree, a 360 degree spray, or in another degree setting proceeding out in one or more nozzles, at the other side of the tube(s). The automatic pesticide, insecticide, and repellant poison delivery system operates on batteries or on a power supply that can be plugged into a wall. The pressure sensor, or pressure transducer of the invention is designed to monitor the level of sprayable content(s) in the system and display that information through logic circuits on the system's liquid crystal or light emitting diode display. The display panel of the invention allows the consumer to program the automatic spray delivery system and to adjust its settings and to view how much is in the cylinder at all times.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide automatic pesticide-insecticide-repellant-poison delivery systems that will overcome the shortcomings of the prior art devices.

An object of the present invention is to provide automatic pesticide-insecticide-repellant-poison delivery systems for automating the delivery of pesticides, insecticides, and repellants and for making the control of pests much more convenient, effective, productive, and deadly.

Another object is to provide automatic pesticide-insecticide-repellant-poison delivery system that has an automated pesticide spray delivery cylinder, of size “X” and shape “Y” that sprays pesticide, insecticide, or repellant onto a designated area in a variety of specific ways (straight-line squirting, mist spray, 30 degree, 45 degree, 60 degree, 90 degree, 180 degree, 360 degree, or another degree setting, etc.), that can sit on the window sill, in the corner of the doorway, by the opening of a door frame, or to be placed inconspicuously in hallways, on the floor next to a door or window, behind a couch or table, or in other areas where pests may travel to prevent them from entering an area by intermittently spraying poison through electromechanically controlled spray bursts as set through the timer, or through the interval timer or through the day/hour programmable switch built into the pesticide delivery system.

Another object is to provide a automate pesticide-insecticide-repellant-poison delivery systems that has logic circuits built into the pesticide or repellant delivery system to allow one to program the delivery system to spray as one desires, such as every 5 minutes, every 10 minutes, every 15 minutes, every 30 minutes, every 45 minutes, every hour, every day, every 2 days, every 3 days, once every 4 days, once every 5 days, once a week, once a month, or however the units are set and programmed. The units can be set to spray often for parties, (i.e. where mosquitoes, or other pests may be a problem).

Another object is to provide automatic pesticide-insecticide-repellant-poison delivery systems that have different types of spray shaping nozzle ends where the unit actually shapes the spray coming out of the electromechanical valve to accommodate different models and spray parameters desired, (i.e., tight line spraying, mist spraying, straight-line squirting, mist spray, 30 degree, 45 degree, 60 degree, 90 degree, 180 degree, 360 degree, or other degree settings, or to use special nozzles where the nozzles themselves can vary the spray degree angle, etc.). It is also envisioned that there can be left-handed and right-handed models made and other models where the models are made with multiple spray jets to spray to the left, to the right, up, down, back, forward, etc., and some right where the unit is placed to get everything. The units can also spray in front and in behind of the units. Thus various spraying arrangements can be developed and marketed.

Another object is to provide automatic pesticide-insecticide-repellant-poison delivery systems that can deliver a pesticide, insecticide or repellant spray in an automated fashion by spraying it through an extended tube to another area where the spraying canister system is placed in one area and the tube is extended a certain distance “X” away from the spraying canister system where the tube will be mounted to an area where it will eventually spray at; and where the tube will have an end where the actual spray may flow in either a tight line spray, a mist spray, a straight-line squirting, a mist spray, a 30 degree, a 45 degree, a 60 degree, a 90 degree, a 180 degree, a 360 degree spray, or in another degree setting proceeding out in one or more nozzles, at the other side of the tube(s).

Another object is to provide automatic pesticide-insecticide-repellant-poison delivery systems that have electromechanical valves designed to trigger the release of the pesticide, insecticide, or the repellant inside the pressurized cylinder or the cartridge of the pesticide, insecticide, or the repellant delivery system upon a programmed timed setting based on a timed interval, and or day/time, for a variety of pesticides, insecticides, and or repellants.

Another object is to provide automatic pesticide-insecticide-repellant-poison delivery systems that will warn the user when the pesticide-insecticide-repellant delivery system is low on pesticide-insecticide-repellant so the user knows that he or she should refill the unit with more poison or spray liquid, or to purchase new canisters or cylinders.

Another object of my invention is to provide automatic insecticide-pesticide-and or repellant spraying devices that are refillable from an economical larger cylinder that can be bought to recharge the automatic spraying units when they become low on pesticides, insecticides, and or repellants.

Another object of my invention is to provide automatic insecticide, pesticide and repellant spraying units that function to spray automatically based on automatic programmable settings that use toxic and or non-toxic chemicals and insecticides, pesticides, and repellants.

Another object of my invention is to provide an optional pressure transducer in the automatic pesticide, insecticide, repellant poison delivery system connected to logic circuits and a display readout that will warn the consumer when the system is low on pesticide, insecticide, or repellant for the intended use for the area that the system is intended to spray.

Another object of my invention is to provide an automatic pesticide, insecticide, repellant poison delivery system with programmable spraying capabilities to deliver pesticides, insecticides, and repellants and poisons as programmed at regular intervals with a liquid crystal display (LCD) readout and an input capability that will enable a consumer to program the device to spray as intended, and so the consumer can read other information such as when the system is low on poison.

Another object is to provide automatic pesticide-insecticide-repellant-poison delivery systems that spray insecticide, pesticide, or repellant automatically based on programmable settings, and is offered in a variety of sizes and shapes (from very small to very large), with spraying capabilities to fit in a variety of locations for strategic and continuous pesticide, insecticide, and repellant delivery and operates on batteries or on a power supply that can be plugged into a wall.

Other objects and advantages of the present invention will become obvious to the reader and it is intended that these objects and advantages are within the scope of the present invention.

To the accomplishment of the above and related objects and advantages, this invention may be embodied in the form illustrated in the accompanying drawings, attention being called to the fact, however, that the drawings are illustrative only, and that changes may be made in the specific construction illustrated.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine that is an automatic pesticide-insecticide-repellant-poison delivery system and or air freshener or disinfectant comprising:

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a fragmentary perspective view of the spray delivery system.

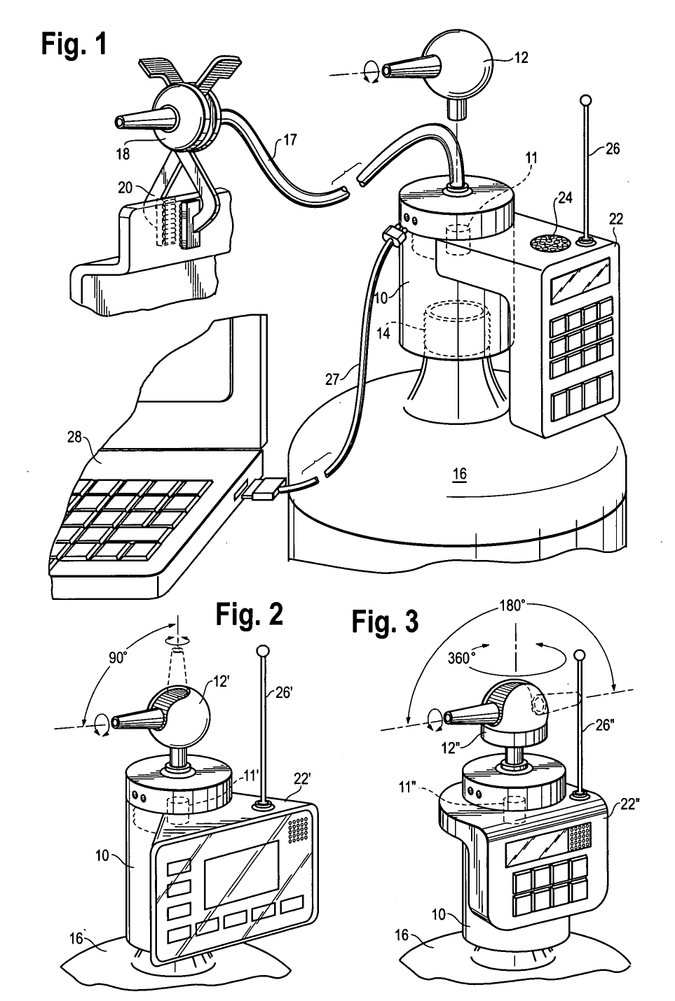

FIG. 2 is a fragmentary perspective view of the spray delivery system with an alternate control panel and display and a 90 degree electromechanical adjustable spray shaping nozzle.

FIG. 3 is a fragmentary perspective view of the spray delivery system showing yet another alternate control panel and display with a fully adjustable electromechanical adjustable spray shaping nozzle.

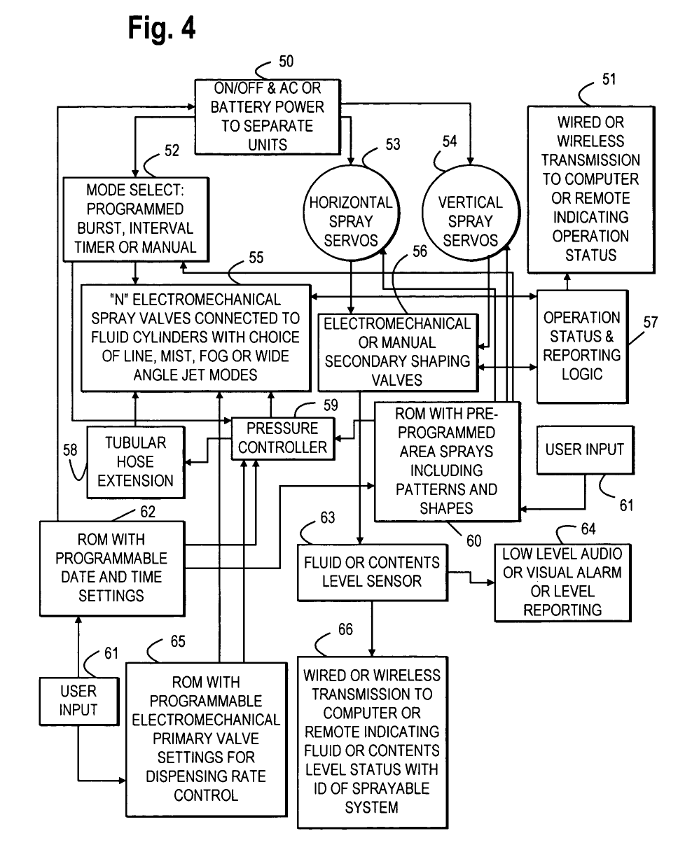

FIG. 4 is a logic circuit block diagram of the spray delivery system illustrating the functional and operational characteristics of the spray delivery system.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### DETAILED DESCRIPTION OF THE INVENTION

Turning now descriptively to the drawings, in which similar reference characters denote similar elements throughout the several views, the attached figures illustrate automatic pesticide, insecticide, repellant, poison, air freshener, disinfectant, or other sprayable substance delivery systems, which comprises a logic circuits containing a circuit that will enable a user to program the sprayable substance delivery system to discharge a spray at a pre-selected time interval, and or day/time interval as chosen in the unit's memory or manually when a user depresses a button.

FIG. 1 depicts a view of the spray delivery system with a cylinder 16 of “X” size having a control panel 22 of “Y” size comprised of a power source, switches, buttons or other interface means to program the spray delivery system and or to activate the spray delivery system manually by depressing a button and an LCD panel or other type of readout panel and a speaker for audible warnings 24 when the system is low on fluid or cylinder content levels. Also shown is an optional antennae 26 built into the control panel having optional RF modulation circuits to allow the spray delivery system to transmit its programmed settings and its unique identification number to a wireless remote or to a computer having a wireless receiver whereby the spray delivery system can also transmit fluid levels through the antennae or low or empty levels as well. Also shown is the primary electromechanical valve 10 that is used for releasing the compressed contents in the cylinder 16 which is connected to the cylinder through threaded means 14. The primary electromechanical valve 10 also has a fluid or contents level sensor 11 built into it that is used for reporting the amount or level of what is in the cylinder at all times and to give low or empty warnings on the LCD panel of the control panel or to give an audible warning on the control panel's speaker 24 or to transmit whether their cylinder(s) are low or empty or to transmit their fluid level or content status, and all their programmed settings and if the system is in proper operating condition along with their identification number(s) through the antennae to a wireless remote or to a computer through the antennae 26 (on deluxe versions). Further, a user may program, re-program, modify or change all the programmable settings of the spray delivery system through wired or wireless means through a computer or a wireless remote through the antennae or wired connection means of the spray delivery system. Also shown on the primary electromechanical valve is a jack for connecting a cable 27 whereby the cable can connect to a computer 28 for transmitting the same information. Also shown in the drawing connected at the top of the primary electromechanical valve is an extendable tube 17 of “Z” length having a secondary spray shaping nozzle 18 on the end of it with attachment means 20 that can be used to attach it to areas that can deliver sprayable contents “Z” length away from the compressed cylinder 16 whereby the extended tube can be disconnected from the primary electromechanical valve to attach either an electromechanical or a non-electromechanical secondary spray shaping nozzle 12 in place of the extended tube directly into the primary electromechanical valve.

FIG. 2 depicts an alternate view of the spray delivery system with an alternate control panel and display and a 90 degree electromechanical adjustable spray shaping nozzle. Shown is the spray delivery system with a cylinder 16 of “X” size having an alternate control panel 22′ of “Y” size comprised of a power source, switches, buttons or other interface means to program the spray delivery system and or to activate the spray delivery system manually by depressing a button and an LCD panel or other type of readout panel and a speaker for audible warnings 24 (shown in FIG. 1) when the system is low on fluid or cylinder content levels. Also shown is an optional antennae 26′ built into the control panel having optional RF modulation circuits to allow the spray delivery system to transmit its programmed settings and its unique identification number to a wireless remote or to a computer having a wireless receiver whereby the spray delivery system can also transmit fluid levels through the antennae or low or empty levels as well. Further, a user may program, re-program, modify or change all the programmable settings of the spray delivery system through wired or wireless means through a computer or a wireless remote through the antennae or wired connection means of the spray delivery system. Also shown is the primary electromechanical valve 10 that is used for releasing the compressed contents in the cylinder 16 which is connected to the cylinder through threaded means 14 as is shown in FIG. 1. The primary electromechanical valve 10 also has a fluid or contents level sensor 11′ built into it that is used for reporting the amount or level of what is in the cylinder at all times and to give low or empty warnings on the LCD panel of the control panel or to give an audible warning on the control panel's speaker 24 (shown in FIG. 1) or to transmit whether their cylinder(s) are low or empty or to transmit their fluid level or content status, and all their programmed settings and if the system is in proper operating condition along with their identification number(s) through the antennae to a wireless remote or to a computer through the antennae 26 (on deluxe versions). Also shown on the primary electromechanical valve is a jack for connecting a cable 27 (shown in FIG. 1) whereby the cable can connect to a computer 28 (shown in FIG. 1) for transmitting the same information. Also shown in the drawing connected at the top of the primary electromechanical valve is an an electromechanical or a non-electromechanical secondary spray shaping nozzle 12′ that can either automatically or manually move in the vertical position from 0-90 degrees that is directly attached into the primary electromechanical valve 10. (It should be noted that the secondary spray shaping nozzle can be manufactured to operate beyond the 0-90 degree settings and or can be manufactured to move in any degree range desired.)

FIG. 3 depicts yet another alternate view of the spray delivery system with yet another alternate control panel and display with a fully adjustable electromechanical adjustable spray shaping nozzle. Shown is the spray delivery system with a cylinder 16 of “X” size having an alternate control panel 22″ of “Y” size comprised of a power source, switches, buttons or other interface means to program the spray delivery system and or to activate the spray delivery system manually by depressing a button and an LCD panel or other type of readout panel and a speaker for audible warnings 24 (shown in FIG. 1) when the system is low on fluid or cylinder content levels. Also shown is an optional antennae 26″ built into the control panel having optional RF modulation circuits to allow the spray delivery system to transmit its programmed settings and its unique identification number to a wireless remote or to a computer having a wireless receiver whereby the spray delivery system can also transmit fluid levels through the antennae or low or empty levels as well. Further, a user may program, re-program, modify or change all the programmable settings of the spray delivery system through wired or wireless means through a computer or a wireless remote through the antennae or wired connection means of the spray delivery system. Also shown is the primary electromechanical valve 10 that is used for releasing the compressed contents in the cylinder 16 which is connected to the cylinder through threaded means 14 (as is shown in FIG. 1). The primary electromechanical valve 10 also has a fluid or contents level sensor 11″ built into it that is used for reporting the amount or level of what is in the cylinder at all times and to give low or empty warnings on the LCD panel of the control panel or to give an audible warning on the control panel's speaker 24 (shown in FIG. 1) or to transmit whether their cylinder(s) are low or empty or to transmit their fluid level or content status, and all their programmed settings and if the system is in proper operating condition along with their identification number(s) through the antennae to a wireless remote or to a computer through the antennae 26″ (on deluxe versions). Also shown on the primary electromechanical valve is a jack for connecting a cable 27 (shown in FIG. 1) whereby the cable can connect to a computer 28 (shown in FIG. 1) for transmitting the same information. Also shown in the drawing connected at the top of the primary electromechanical valve is an an electromechanical or a non-electromechanical secondary spray shaping nozzle 12″ that can either automatically or manually move in the vertical position from 0-90 degrees, or in the horizontal position 0-360 degrees that is directly attached into the primary electromechanical valve 10. (It should be noted that the secondary spray shaping nozzle can be manufactured to operate beyond the 0-90 vertical and or 0-360 degree settings and or can be manufactured to move in any degree range desired.)

FIG. 4 is a logic circuit block diagram of the spray delivery system illustrating the functional and operational characteristics of the spray delivery system. Shown in the logic circuit block diagram are the following logic modules: “ON/OFF & AC OR BATTERY POWER TO SEPARATE UNITS” 50 which is a module utilized to turn the system on or off and or and to put the system in stand-by mode once it is on to operate in: programmed mode, interval timer mode or in manual mode as desired through the: “MODE SELECT: PROGRAMMED BURST, INTERVAL TIMER OR MANUAL” module 52; 50 is a module that also drives and gives power to the: “HORIZONTAL SPRAY SERVOS” 53 module; and to the: “VERTICAL SPRAY SERVOS” 54 module which are motorized modules that turn and direct the secondary shaping spray nozzle in models with an electromechanical or a manual secondary shaping spray nozzle (it is also assumed that non servo designed systems can be developed); 50 also gives power to the entire system and gives power to the logic circuits. The “MODE SELECT: PROGRAMMED BURST, INTERVAL TIMER OR MANUAL” module 52 operates “N” ELECTROMECHANICAL SPRAY VALVES CONNECTED TO FLUID CYCLINDERS WITH CHOICE OF LINE, MIST, FOG, OR WIDE ANGLE JET MODES” 55 which is the primary electromechanical valve that dispenses compressed cylinder contents; 52 also operates the: “PRESSURE CONTROLLER” 59 module which in turn feeds and controls 55 as well. The: “HORIZONTAL SPRAY SERVOS” 53 module and the: VERTICAL SPRAY SERVOS” 54 module control the: “ELECTROMECHANICAL OR MANUAL SECONDARY SHAPING VALVES” 56 module that direct and angle the spray that proceeds out from the primary electromechanical valve 55 module from the cylinder(s) in all variations of the automatic spray delivery system(s) which further communicate information to the: “OPERATION STATUS & REPORTING LOGIC” 57 module; which in turn sends information to through: “WIRED OR WIRELESS TRANSMISSION TO COMPUTER OR REMOTE INDICATING OPERATION STATUS” 51 module. Further, the “OPERATION STATUS & REPORTING LOGIC” 57 module communicates in a bidirectional manner to the: “N” ELECTROMECHANICAL SPRAY VALVES CONNECTED TO FLUID CYCLINDERS WITH CHOICE OF LINE, MIST, FOG, OR WIDE ANGLE JET MODES” 55 module. The: “ELECTROMECHANICAL OR MANUAL SECONDARY SHAPING VALVES” 56 module also communicate with a: “FLUID OR CONTENTS LEVEL SENSOR” 63 module which in turn communicates with the: “LOW LEVEL AUDIO OR VISUAL ALARM OR LEVEL REPORTING” 64 module and with the: “WIRED OR WIRELESS TRANSMISSION TO COMPUTER OR REMOTE INDICATING FLUID OR CONTENTS LEVEL STATUS WITH ID OF SPRAYABLE SYSTEM” 66 module. There is also a “USER INPUT” 61 module that is comprised of a number of input means that includes a manual control panel shown in FIGS. 1, 2 and 3 and also to include wired and wireless “USER INPUT” 61 to include a wired or a wireless remote and or a computer to program and or to view the functions of the spray delivery system and to view how the spray delivery system has been programmed and to modify the settings at any time to include the control panel means of the spray delivery system in all of the variations shown and which can be varied in manufacture to be developed in various forms and also to include wired connections whereby a cable can be connected to the spray delivery system as shown in FIG. 1, and or antennae means including RF modulation circuits built into the circuitry of the control panel that will allow a user to utilize a wireless remote or a computer with wireless means to access the antennae and the RF modulation circuits to program the spray delivery system or to view operating settings or view or see all the settings of the spray delivery system including the remaining contents of the cylinder if they are full, low, empty or any variation thereof, at any time and or a user may program, re-program, modify or change all the programmable settings of the spray delivery system through the control panel on the spray delivery system or through a wired connection or through wireless means through a computer or a wireless remote through the antennae or wired connection means connected to the spray delivery system whereby each spray delivery system is identified with a unique identification number or frequency and whereby a plurality of spray delivery systems can be selectively programmed whereby the status of the functions and the levels of the cylinder contents can be viewed and the programmed functions of the spray delivery systems can be viewed with one wireless remote or said functions can be programmed or viewed with wired or wireless connections to one wireless remote or with one computer. Further, the: “USER INPUT” 61 can be used to program and input and change information in the: “ROM WITH PRE-PROGRAMMED AREA SPRAYS INCLUDING PATTERNS AND SHAPES” 60 module which in turn communicates with the: “MODE SELECT: PROGRAMMED BURST, INTERVAL TIMER OR MANUAL” module 52 and with the: “HORIZONTAL SPRAY SERVOS” 53 module and the: VERTICAL SPRAY SERVOS” 54 module and with the: “PRESSURE CONTROLLER” 59 module. Further, the “USER INPUT” 61 module can be used to program and input and change information in the: “ROM WITH PROGRAMMABLE ELECTROMECHANICAL PRIMARY VALVE SETTINGS FOR DISPENSING RATE CONTROL” 65 module which in turn communicates with the: “PRESSURE CONTROLLER” 59 module and with the “N” ELECTROMECHANICAL SPRAY VALVES CONNECTED TO FLUID CYCLINDERS WITH CHOICE OF LINE, MIST, FOG, OR WIDE ANGLE JET MODES” 55 module. Also the: “USER INPUT” 61 can be used to program and input and change information in the: “ROM WITH PROGRAMMABLE DATE AND TIME SETTINGS” 62 module which in turn communicates with the: “PRESSURE CONTROLLER” 59 module and with the: “ON/OFF & AC OR BATTERY POWER TO SEPARATE UNITS” 50 module and with the: “ROM WITH PRE-PROGRAMMED AREA SPRAYS INCLUDING PATTERNS AND SHAPES” 60 module. In variations of the design utilizing versions where there is an extended tube version to extend spraying from the cylinder a certain distance from the cylinder utilizing an “extended tube” having a nozzle affixed at the end of the “extended tube” there is the: “TUBULAR HOSE EXTENSION” 58 that connects to the: “N” ELECTROMECHANICAL SPRAY VALVES CONNECTED TO FLUID CYCLINDERS WITH CHOICE OF LINE, MIST, FOG, OR WIDE ANGLE JET MODES” 55 module.

Other component(s) of the invention includes a logic circuit that will warn the user when the cylinder is low on poison through a pressure transducer when the system is low on poison or to indicate how much is left in the cylinder at all times and also to tell the user all set operating parameters that were set by the user by scrolling through the buttons on the interfacing panel when going through memory on the unit.

Another component of the invention includes a primary electromechanical valve that opens to let the sprayable contents escape when the automated spraying mechanism of the sprayable delivery system is activated.

The spray cylinder component of the invention contains the pressurized insecticides, pesticides, repellants, air freshener(s), disinfectants, or other sprayable substances used by the automated spray system. The electromechanical valve of the invention can be controlled by the logic circuits of the system to release contents of the cylinder(s) in programmable amounts automatically as according to programmable date/time circuits or as to programmed or set intervals or the system may discharge contents through manual means if a user depresses a button or a switch on the system that activates the electromechanical valve that connects to the pressurized spray cylinder when activated releases a controlled burst (which is settable) of insecticide, pesticide, repellant, air freshener, or other sprayable item when programmed to do so, or through manual election by the control circuits of the automatic spray delivery system. The control circuits of the invention allow the user to set how often the automatic spray delivery system discharges a spray burst from the cylinder to activate the electromechanical valve to release a controlled burst of the cylinder contents. The logic through a sensor also tells the consumer how full the cylinder is and if the cylinder is low on gas, liquid, powder, oil or other sprayable substance so the user can recharge the cylinders or purchase new systems. The spray nozzles allow the sprayable substances to be directed as desired for spraying purposes and can be adjusted by the user to spray as desired with adjustable nozzles to spray in a number of ways, including tight line squirts, to fog an area, to be directed to spray certain areas and in certain angles, or be fitted In manufacturing to spray in a finite number of ways: (i.e., tight line spraying, mist spraying, straight-line squirting, mist spray, 30 degree, 45 degree, 60 degree, 90 degree, 180 degree, 360 degree, or other degree settings, or to use special nozzles where the nozzles themselves can vary the spray degree angle, etc.). It is also envisioned that there can be left-handed and right-handed models made and other models where the models are made with multiple spray jets to spray to the left, to the right, up, down, back, forward, etc., and some right where the unit is placed to get everything. The units can also spray in front and in behind of the units. Thus various spraying arrangements can be developed and marketed. Extended tubes can deliver a pesticide, repellant, air freshener, disinfectant, poisons, in an automated fashion by spraying it through an extended tube to another area where the spraying canister system is placed in one area and the tube is extended a certain distance “X” away from the spraying canister system where the tube will be mounted to an area where it will eventually spray at; and where the tube will have an end where the actual spray may flow in either a tight line spray, a mist spray, a straight-line squirting, a mist spray, where it can fog an area, perform in a 30 degree, a 45 degree, a 60 degree, a 90 degree, a 180 degree, a 360 degree spray, or in another degree setting proceeding out in one or more nozzles, at the other side of the tube(s) where the shape of the spray may be varied in any way by the nozzle(s). The extended tube can be made out of any material that will not react with the pesticides, insecticides, or the repellants.

The automatic spray delivery system operates on batteries or on a power supply that can be plugged into a wall. The battery system or power source of the unit has to be powerful enough to drive the system. The spray cylinder can be made out of any material that can withstand pressure and retain the liquids and gasses and is commonly found in the industry and used for such purposes where an electromechanical valve can be applied with control circuits to release the contents in a programmable fashion. The cylinder can be any size and shape and be made out of any material, plastic, metal or any other material. It can also be made to be made refillable or disposable. Furthermore, the spray cylinders models are to be made in a variety of model sizes to contain pesticides, insecticides and repellants under different pressures so their spray areas can extend to different lengths. It is contemplated that different models will be provided in the marketplace that will be rated for different area needs to cover different pesticide, insecticide, and repellant needs for all kinds of spraying needs over different areas over the entire type of spraying functions. Thus various spraying arrangements can be developed and marketed some with small cylinders under small pressurization for only a few feet and some for great distances over several feet or yards, under greater pressurization. The spray nozzles can be made out of plastic or metal, or another material, they can be attached onto the unit or they can be built into the casing of the automatic spray delivery system.

The pressure sensor, or pressure transducer of the invention is designed to monitor the level of the sprayable contents in the system and display the level of fullness information through logic circuits on the system's liquid crystal or light emitting diode display. The pressure sensor, or pressure transducer of the invention is designed to monitor the level of the sprayable content(s) in the system and display that information through logic circuits on the system's liquid crystal or light emitting diode display. The pressure sensor, or pressure transducer of the invention is designed to monitor the level of the pesticide, insecticide and or the repellant in the system and display that information through logic circuits on the system's liquid crystal or light emitting diode display. The pressure sensor or the pressure transducer is as those commonly found in the industry. Further, the pressure sensor on deluxe models will send a low or empty signal along with the spray delivery unit's identification number to a remote wireless warning device whereby there can be one or more spray delivery units reporting to the same remote wireless warning device to warn users when spray delivery unit(s) are low or empty.

The control panel and the display panel of the invention allows the consumer to program the spray delivery system and to adjust its programmable settings and to view how much is in the cylinder at all times no matter what it contains and to display a message if it is low or empty.

The electromechanical valve of the invention connects to the pressurized spray cylinder and when activated releases a controlled burst (which is settable) of insecticide, pesticide, repellant, air freshener, or other sprayable contents when programmed to do so or by the user depressing a manual button through the control circuits of the automatic spray delivery system. The duration and the magnitude of the spray burst released by the electromechanical release valve is controlled by the control circuits of the delivery system by how far open and how long the valve remains open. The nozzles at the opening at the end of the electromechanical valve or at the end of the tubes attached to the electromechanical valve shape the stream or the shape of the pesticide, insecticide or repellant stream into the atmosphere or into the area where they are to be sprayed. The electromechanical valve can be made out of a variety of materials including plastic and or metal parts and can be any size to fit around the cylinder(s) proportionately.

The control circuits of the invention allow the user to set how often the automatic spray delivery system discharges a spray burst from the cylinder(s) to activate the electromechanical valve to release a controlled burst of the cylinder(s) contents. They also tell the consumer how full the cylinder is and if the cylinder is low on gas or liquid or other sprayable substances so the user can recharge the cylinders or purchase new systems. The control circuits also control how wide the electromechanical valve opens to release the sprayable contents and they also control how long the electromechanical valve remains open when discharging pressurized contents. They also warn the user when the system is low on sprayable contents through an audible beep, or other visual means. The control circuits contain all the buttons for programming and for displaying information for the operation of the delivery system.

The display panel of the invention allows the consumer to program the spray delivery system and to adjust its settings and to view how much of the sprayable contents are in the cylinder at all times. The display of the automatic pesticide, insecticide, repellant poison delivery system uses a liquid crystal display or a light emitting diode or other such display used to help the consumer adjust the settings of the system and to view the pressure level of the system.

The automatic pesticide, insecticide, repellant poison delivery, or other sprayable substance system has a number or main components and subcomponents that are interconnected as follows:

The spray cylinder can contain pesticide, insecticide, repellant, air freshener, disinfectant or another ingredient under pressure that is connected to an electromechanical valve which is controlled by logic circuits and buttons in the control circuit portion of the system which a consumer can use to program the system for controlled release of the pesticide, insecticide, or the repellant as desired. The control circuits also contain a display panel for assisting in the programming of the system and for viewing the pressure of the system. The electromechanical valve of the system opens briefly when the logic circuits are activated and the pesticide, insecticide, and or repellant is discharged through the electromechanical valve and out from the secondary shaping valves and out from the cylinder. When the system is low on pressure for intended operation for the area that the system is supposed to cover, the display panel will indicate that information on deluxe models. Different models and sizes of the automated pesticide, insecticide, repellant poison delivery system are contemplated with varying cylinder sizes to accommodate different spray area needs and to fit in areas where there are different constraints and requirements. Canisters can be made with double adhesive tape to mount the units, or for more permanent installations, mounting brackets with screws can be provided, or stand alone models can also be provided. Systems under different pressures can also be provided so that the spray ejected from the units can reach certain area parameters for different needs (for example, some units can be made to spray an area of (3) three feet, others (5) five feet, others (10) ten feet, others (20) twenty feet, others (30) thirty feet, etc).

The spray cylinder contains pesticide, insecticide, repellant, air freshener or other sprayable contents under pressure that is connected to an electromechanical valve which is controlled by logic circuits and buttons in the control circuit portion of the system which a consumer can use to program the system for controlled release of the pesticide, insecticide, or the repellant as desired. The control circuits also contain a display panel for assisting in the programming of the system and for viewing the pressure of the system. The electromechanical valve of the system opens briefly when the logic circuits are activated and the pesticide, insecticide, and or repellant is discharged through the electromechanical valve and out from the secondary shaping valves and out from the cylinder. When the system is low on pressure for intended operation for the area that the system is supposed to cover, the display panel will indicate that information on deluxe models. Thus, when programmed and installed, the automatic pesticide, insecticide, repellant, poison, air freshener, disinfectant or any type of spray or powder delivery system will intermittently deliver and discharge a burst of pesticide, insecticide and or repellant or other item at controlled intervals as programmed until the unit is out of liquid/gas/powder and it will also warn the consumer when the system is low on pressure for the intended area it is covering through an audible or a visual indicator on the system's display or control panel.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A machine that is an automatic pesticide, insecticide, repellant, poison, air freshener, disinfectant, or other type of spray delivery system that delivers sprayable substances comprising:
i. means to provide an automated spray delivery system through compressed cylinder(s) of “X” size to deliver sprayable liquids, gasses, oils, powders or to deliver sprayable substances through electromechanical means through devices that are programmable to release spray bursts or compressed contents at certain times and or dates as programmed or to optionally release contents from cylinder(s) through optional manual means by depressing an optional manual button, switch or other optional manual control means to open the electromechanical or a mechanical valve to release compressed content(s);
ii. means to provide portable battery operated and or AC operated spray delivery systems that can be strategically placed in places of interest and canisters designed and filled for specific applications such as pesticides, insecticides, poisons, repellants, air fresheners, disinfectants, chlorine, powders, fertilizer, weed killer, vegetation killer, or other sprayable substances, (or such other ingredients to be used for a myriad of other uses that might be of interest) to dispense whatever might be of interest to control or dispense whatever may be desired;
iii. means to provide automatic spray delivery systems with canisters and or cylinders and whereby there is a primary electromechanical valve that controls the release of compressed content(s) from cylinder(s) through the logic systems of the system or when a user depresses a manual button and whereby there are manual or electromechanical secondary spray shaping valves that are removeable, refillable, replaceable and adjustable that shape the angle, direction and shape of the flow of dispensed contents that are released from the cylinder(s) once they are discharged from the electromechanical valve in at least three model variations: 1) whereby contents are discharged through a non-motorized secondary spray shaping nozzle whereby contents of the cylinder are shaped direcly by a manually adjustable secondary spray shaping nozzle to adjust the shape of the spray flow and angle direction of the spray stream as desired; 2) whereby contents are discharged through a motorized secondary spray shaping nozzle whereby contents of the cylinder are shaped direcly by an electromechanically driven secondary spray shaping nozzle that automatically adjusts the shape of the spray flow and angle direction of the spray stream as the user programs the automatic spray delivery system to deliver sprayable contents to desired angular directions and for the degrees and rotations desired by selecting programmed servo motor control selections or by programming the unit through the system's control panel to tell the system: a) how much to rotate the nozzle horizontally 0-360 degrees (or other degrees that may vary in manufacture) when spraying and where to return in position to reset for the next spray cycle, also to tell the spray delivery system the speed of horizontal rotation the secondary spray shaping nozzle will rotate so that it can be selected; b) how much to turn the nozzle in the vertical position 0-180 degrees (or other degrees that may vary in manufacture) when spraying and where to return in position to reset for the next spray cycle, also to tell the unit the speed of vertical movement that the nozzle will travel when spraying where it can be selected; and c) to turn and rotate the nozzle head to adjust the spray flow for tight line spraying, mist spraying, to fog an area, to fan spray an area for desired angles or to spray in other desired ways; 3) whereby the automatic spray delivery system may be made available where the electromechanical valve can be made to optionally connect to an automatic electromechanical or a manual secondary spray shaping valve or directly to an extendable tube of “X” length to be as long as desired with either a manual or an automatic electromechanical secondary spray shaping valve attached at the end of it to shape the spray flow and angles of the spray stream for the contents that will be released from the spray cylinder with optional attachment means to attach the said secondary spray shaping valve to places to secure it; whereby in all designs and variations they all have the functionality and capability in the programming to control the electromechanical valve through the control panel to programmably set: 1) how long to keep the electromechanical valve open; 2) how wide to keep the electromechanical valve open; while each model still has the capability through a manual switch or button to release contents under pressure at any time when a user depresses a button which activates the electromechanical valve to release contents as long as the user depresses the button until the cylinder empties;
iv. means to provide an automatic spray delivery system with an automatic clock/date timing circuit and logic system and an interface that will allow a user to set and program the automatic spray delivery system to spray in an unattended fashion automatically at certain dates and times and or intervals as programmed to alleviate pest problems, or to deliver poisons, or to spray air fresheners, disinfectants, or other sprayable contents for a particular application in an unattended fashion so that areas of a house or apartment or zone can be automatically controlled as desired which can be very useful for gardens, patios, or in commercial areas, and keep such areas sprayed;
v. means to provide automatic spray delivery systems in different canister or cylinder sizes including very small sizes to large sizes to allow a user to place such devices in small areas or larger systems with hose extenders that can extend a spray nozzle to a strategic area where it would be hard to fit the canister so that boundaries of pesticide may be formed by spraying in line squirts, in area squirts, and in fog squirts, to accommodate window sills, doorways, hallways, and outdoor areas, as the custom designed pesticide delivery units in our design allow you to cover areas where pests may break through where they normally enter homes and apartments;
vi. means to provide logic and memory circuits to contain the memory settings set by the user to remember the date and time intervals set in order for the automatic spray system to disburse contents from its cylinders as the user desires whereby the present invention generally comprises logic circuits containing a circuit and an interface that will enable a user to program the automatic spray delivery system to discharge a spray of its contents at a pre-selected time interval or day/time interval chosen and stored in the unit's memory;
vii. means to include a logic circuit that will warn the user when the cylinder is low on contents or to display how much a cylinder has inside of it and display the same on the automatic spray delivery system's display panel through the use of a pressure transducer and to indicate when the system is low on contents;
viii. means to include a primary electromechanical valve that opens to let contents escape from the compressed cylinder when the automated spraying mechanism of the automatic spray delivery system is activated and to close when the automated spraying mechanism of the automatic spray delivery system is de-activated when the logic circuit controls it as programmed or to optionally release contents from cylinder(s) through optional manual means by depressing an optional manual button, switch or other optional manual control means to open the electromechanical or a mechanical valve to release compressed content(s);
ix. means to provide a least one compressed spray cylinder component in the automatic spray delivery system to deliver sprayable contents to desired areas used by the automated spray system;
x. means containing a primary electromechanical valve in the automated spray delivery system which connects to the pressurized spray cylinder whereby when activated the spray system releases a controlled burst of contents, (whose spray duration(s) is/are programmably settable), and whereby the spray(s) occur and function when programmed to do so as determined by the control circuits of the automatic spray delivery system and whereby the control circuits allow the user to set how often the automatic spray delivery system discharges a spray burst from the cylinder whereby the logic circuits activate the electromechanical valve to release (a) controlled burst(s) of the cylinder contents or to optionally release contents from cylinder(s) through optional manual means by depressing an optional manual button, switch or other optional manual control means to open the electromechanical or a mechanical valve to release compressed content(s);
xi. means to provide removeable, replaceable and adjustable and or automatic electromechanical and or manual secondary spray nozzles that will allow the automated spay delivery system to be directed as desired for spraying purposes whereby the user or consumer can adjust the nozzles for flow and direction for spray patterns and angle and pressure characteristics as desired such as: tight line spraying, mist spraying, fog area spraying, adjustable angled fanned spraying to spray areas having different widths, to spray rotationally in the horizontal and or in the vertical direction from 0-360 degrees or to fan spray in 0-30 degree, 0-45 degree, 0-60 degree, 0-90 degree, 0-180 degree, 0-360 degree, or to adjust the spray delivery system to other degree settings, or to use special electromechanically automatically adjustable (through the programmable logic of the spray delivery system) or manually adjustable secondary spray shaping nozzles where the nozzles themselves can be turned and adjusted (to vary the spray, flow and degree angle, etc. and whereby it is also envisioned that there can be left-handed and right-handed models made and other models where the models are made with multiple spray jets to spray to the left, to the right, up, down, back, forward, etc., and some right where the unit is placed to get everything and whereby the units can also spray in front and in behind of the units where various spraying arrangements can be developed and marketed and where extended tubes can deliver a pesticide or repellant spray in an automated fashion by spraying it through an extended tube to another area where the spraying canister or cylinder system is placed in one area and the tube is extended a certain distance “X” away from the spraying canister system where the tube will be mounted to an area where it will eventually spray at; and where the tube will have an end with a nozzle that can shape the spray of the contents coming out of the cylinder where the actual spray may flow in either a tight line spray, a mist spray, to fog an area, adjustable angled fanned spraying to spray areas having different widths, having a 0-30 degree, a 0-45 degree, a 0-60 degree, a 0-90 degree, a 0-180 degree, a 0-360 degree spray, or any other degree setting proceeding out in one or more nozzles, at the other side of the tube(s) whereby the spray delivery system can either spray a stream by rotating horizontally or vertically as programmed when spraying or whereby the spray delivery system can dispense contents without rotating in a fixed angular position for a specific date/time and or interval chosen as programmed or as operated manually by the user through the control panel or through the wired or wireless input means of the spray delivery system;
xii. means to provide a pressure sensor, or pressure transducer to monitor cylinder contents in the automated spray system and means to display that information through logic circuits on the system's Liquid Crystal Display Or Light Emitting Diode Display whereby the Display Panel of the system allows the user to program the spray delivery system, and to adjust its settings, and to view how much remains in the cylinder(s) at all times;
xiii. means to provide an automatic spray delivery system that has an automated spray delivery cylinder, of size “X” and shape “Y” that sprays contents onto a designated area in a variety of specific ways (straight-line squirting, mist spray, to fog an area, to fan spray an area to a particular angle desired to rotate and vary a spray vertically or horzontally to a specific degree desired either automatically or manually through electromechanical or manual means from 0-360 degrees or from 0-30 degree, 0-45 degree, 0-60 degree, 0-90 degree, 0-180 degree, 0-360 degree, or to another degree setting, etc.; or to vary the degree settings incrementally or to deliver contents through a hose as in an injection as a spray or as in a liquid injection), that can sit on the window sill, in the corner of the doorway, by the opening of a door frame, or to be placed inconspicuously in hallways, on the floor next to a door or window, behind a couch or table, or in other areas where pests may travel to prevent them from entering an area by intermittently spraying poison, [or for myriads of other application(s)] through electromechanically controlled spray bursts as set through the built-in date/time timer, or through the interval timer or through the date/time programmable switch built into the automated spray delivery system in various optional variations of the invention or to optionally release contents from cylinder(s) through optional manual means by depressing a manual button, switch or other optional manual control means to open the electromechanical or a mechanical valve to release compressed content(s);
xiv. means to provide logic circuits and an interface to control the automatic spray delivery system to allow one to program or adjust the delivery system(s) to spray through an interval timer in interval increments as one desires, such as every 5 minutes, every 10 minutes, every 15 minutes, every 30 minutes, every 45 minutes, every hour, every day, every 2 days, every 3 days, once every 4 days, once every 5 days, once a week, once a month, or however the units are set and programmed whereby the unit(s) can be easily reset or changed to spray more often for parties, (i.e. where mosquitoes, or other pests may be a problem) or to disinfect areas or to freshen areas by putting air fresheners in the air, or spray delivery systems that can be utilized for other application(s) where one can exchange cylinder(s) for any application desired or to change them to operate as desired as more or less often through settings by varying the interval timer “more or less” as desired with a minimal adjustment by adjusting the time(s) selected;
xv. means to provide an automatic spray delivery system having different types of spray shaping nozzle ends where a user can manually or automatically adjust electromechanically driven programmed secondary spray shaping nozzles automatically through the logic and memory of the spray delivery system whereby the unit actually shapes the spray coming out of the electromechanical valve to accommodate different models and spray parameters desired, (i.e., tight line spraying, mist spraying, straight-line squirting, to fog spray an area, to fan spray an area for particular angle(s) desired, to rotate sprays horizontally and vertically automatically and or manually through electromechanical or manual secondary spray shaping nozzles in 0-30 degree, 0-45 degree, 0-60 degree, 0-90 degree, 0-180 degree, 0-360 degree, or other degree settings or incrementally, or to use special nozzles where the nozzles themselves can vary the spray degree angle, etc.) whereby it is also envisioned that there can be left-handed and right-handed models made and other models where the models are made with multiple spray jets to spray to the left, to the right, up, down, back, forward, etc., and some where the unit is placed to fog an area and get everything whereby a unit can also spray in front and in behind of the said units whereby it is thus conceived that various spraying arrangements can be developed and marketed whereby all models can be made to function to optionally release contents from cylinder(s) through optional manual means by depressing an optional manual button, switch or other optional manual control means to open the electromechanical or a mechanical valve to release compressed content(s);
xvi. means to provide an automatic spray delivery system that can deliver a spray in an automated fashion by spraying it through an extended tube to another area where the spraying canister system is placed in one area and the tube is extended a certain distance “X” away from the spraying canister system where the tube will be mounted to an area where it will eventually spray at; and where the tube will have an end where the actual spray may flow in either a straight-line squirting, a mist spray, to fog an area, to fan spray an area at desired width lengths, to spray in a 0-30 degree, a 0-45 degree, a 0-60 degree, a 0-90 degree, a 0-180 degree, a 0-360 degree spray, or in another degree setting proceeding out in one or more nozzles, at the other side of the tube(s);
xvii. means to different models and logic systems connecting to different sized spray cylinders containing pressurized sprayable contents used by the automated spray system whereby the spray cylinder can be made out of any material that can withstand pressure and whereby the cylinder(s) retain the liquids, gasses, and or powder(s) that are commonly found in the industry and used for desired purposes where an electromechanical valve can be applied with logic control circuits to release the contents in a programmable fashion whereby the cylinder can be any size and shape and be made out of plastic, metal or any other material and where it can also be made to be made refillable and or disposable and where the spray cylinders models are to be made in a variety of model sizes to contain pesticides, insecticides, poisons, repellants, air fresheners, disinfectants, fertilizers, vegetation killers, weed killers, or other sprayable items, under different pressures so their spray areas can extend to different lengths, and or for different application(s) and where it is contemplated that different models will be provided in the marketplace that will be rated for different area needs to cover different needs for all kinds of spraying needs over different areas over the entire type of spraying functions: (i.e., tight line spraying, mist spraying, straight-line squirting, to fan spray at desired widths, to spray in vertical and and horizontal rotations in a 0-30 degree, 0-45 degree, 0-60 degree, 0-90 degree, 0-180 degree, 0-360 degree, or other degree settings, or to use special nozzles where the secondary spray shaping nozzles themselves can vary the spray degree angle, and so on, whereby it is also envisioned that there can be left-handed and right-handed models made and other models where the models are made with multiple spray jets to spray to the left, to the right, up, down, back, forward, etc., and some that can fog an area where the unit is placed to get everything and whereby the units can also spray in front and in behind of the units whereby it is also conceived that various spraying arrangements can be developed and marketed some with small cylinders under small pressurization for only a few feet and some for great distances over several feet or yards, under greater pressurization whereby all models can also be made to function to optionally release contents from cylinder(s) through optional manual means by depressing an optional manual button, switch or other optional manual control means to open the electromechanical or a mechanical valve to release compressed content(s);
xviii. means to provide an electromechanical valve in an automatic spray delivery system that has the functionality to control the duration and the magnitude of the spray burst released by the electromechanical release valve being controlled by the control circuits of the delivery system to control how far the valve will open and how long the valve remains open whereby the nozzles at the opening at the end of the electromechanical valve or at the end of the tubes attached to the electromechanical valve shape the stream or the shape of the pesticide, insecticide or repellant stream into the atmosphere or into the area where they are to be sprayed and whereby the electromechanical valve can be made out of a variety of materials including plastic and or metal parts and can be any size to fit around the cylinder(s) proportionately whereby said models having said electromechanical valve also have the functionality to function to optionally release contents from cylinder(s) through optional manual means by depressing an optional manual button, switch or other optional manual control means to open the electromechanical or a mechanical valve to release compressed content(s);
xix. means to provide logic control circuits that control how wide and how long the electromechanical discharge valve remains opens to release the compressed contents in the cylinders when discharging pressurized contents and whereby said logic control circuits provide an audible beep and or visual means to warn the user that the system is low on cylinder contents or that the battery is low on power and whereby the logic control circuits and the interface contain all the buttons for programming the system and for displaying and scrolling through the functions and settings and for the operation of the automatic spray delivery system and whereby there is a ROM in the system that provides easy to use step by step instructions on how to use the system on the LCD or other readout panel of the system;
xx. means to provide an electromechanical valve on the automatic spray delivery system that opens when the logic circuits are activated and whereby the contents are discharged as programmed through the electromechanical valve and whereby the contents are disbursed into the atmosphere shaped by the secondary shaping valve nozzles as they are sprayed as spraying extends out from the cylinder whereby all models can also be made to function to optionally release contents from cylinder(s) through optional manual means by depressing an optional manual button, switch or other optional manual control means to open the electromechanical or a mechanical valve to release compressed content(s);
xxi. means to provide an automatic spray delivery system with attachment means to allow a user to attach said unit(s) to areas with ease either by hanging the units with a hook, or through double adhesive tape, or other fastening or attachment means, or to provide other support means to have the units stand up for themselves with legs or a molded bottom to support themselves appropriately in an desired area whereas systems can be secured with double adhesive tape to mount the units, or for more permanent installations, mounting brackets with screws can be provided, or in alternate variations, stand alone models can also be provided;
xxii. means to provide automatic spray systems under different pressures so that the spray ejected from the units can reach certain area parameters for different needs (for example, some units can be made to spray an area of (3) three feet, others (5) five feet, others (10) ten feet, others (20) twenty feet, others (30) thirty feet, etc) whereby it is understood that any number and kind of spray system(s) can be developed to spray and cover different areas covering different needs by adjusting the size of the cylinders, and the type of compression and pressures used in manufacturing to cover different applications and requirements;
xxiii. means to provide a deluxe version of an advanced automated spray delivery system having the functionalities of the aforementioned claims whereby it is also comprised of circuits, logic, a transmitting antennae, and a wireless remote or a jack on the spray delivery system that will allow a user to connect the spray delivery system to a computer through wired or wireless means whereby the spray delivery system can send transmissions to a computer; and a wireless receiver for a computer or a handheld wireless remote to receive transmission(s) from one or more automated spray delivery systems that will allow the spray delivery systems to each transmit their unique identification numbers through RF transmitting modulation circuits that will allow the spray delivery system(s) to send information to the wireless remote or to a computer through wireless means or through wired means to state whether their cylinder(s) are low or empty or to transmit their level status, and all their programmed settings and if the system is in proper operating condition along with their identification number(s);
xxiv. means to provide logic and circuitry in an advanced spray delivery system whereby operating information or sprayable content(s) or fluid or cylinder content level(s) are displayed on the spray delivery system's LCD control panel readout along with the sprayable system's identification number or transmitted through wireless or wired means to a computer or to a wireless remote from a jack on the spray delivery system having a connection to connect a cable to connect it to a computer or whereby the spray delivery system may be designed with RF modulation circuits and an antennae to transmit said information along with a spray system identification number along with transmittable information whereby the sprayable delivery system has memory and switches that can be used to recall and to change and vary the programmed operating information on the system's LCD panel by depressing button(s) or scrollable switch(es), or other user interfaces whereby a user can: 1) see or change how the unit has been programmed to function with all information and settings that he or she has programmed the unit to discharge content(s) of cylinder(s) at date(s)/time(s), and or intervals that the unit has been chosen to discharge with all parameter(s) chosen and to vary them; 2) to see or change how wide the electromechanical valve will open to discharge the contents and for how long of a duration; 3) to see or change how the secondary electromechanical shaping valve nozzle will sweep or rotate in the vertical and in the horizontal direction(s) once activated; 4) to see or change the shape of the flow of the stream of the spray by adjusting the secondary electromechanical shaping valve nozzle by turning it to alter the secondary electromechanical shaping valve nozzle to perform as desired to perform to spray in a tight line spray, in a mist, to fog an area, to perform in an angled fan spray, or to spray in some other fashion; 5) see or change the timing or speed for the sweeping of the movement of the vertical and the horizontal movement of the secondary shaping valve and also the order in which it rotates whereby it can rotate vertically or horizontally back and forth, once, any number or times, choose the order in which it rotates first horizontal then vertical or vice versa, etc in any variation; 6) see or change the programmable setting(s) for the dispensing rate control of the primary electromechanical valve that controls the dispensing of the cylinder contents; further, a user may view or see all the settings of the spray delivery system including the remaining contents of the cylinder if they are full, low, empty or any variation thereof, at any time and or a user may program, re-program, modify or change all the programmable settings of the spray delivery system through the control panel on the spray delivery system or through a wired connection or through wireless means through a computer or a wireless remote through the antennae or wired connection means connected to the spray delivery system whereby each spray delivery system is identified with a unique identification number or frequency and whereby a plurality of spray delivery systems can be selectively programmed whereby the status of the functions and the levels of the cylinder contents can be viewed and the programmed functions of the spray delivery systems can be viewed with one wireless remote or said functions can be programmed or viewed with wired or wireless connections to one wireless remote or with one computer;
xxv. means to provide logic, circuitry and control means to program, re-program and modify the settings of the spray delivery system and to view the settings of the spray delivery system on the spray delivery system's control panel and to view or change the settings of one or more spray delivery systems through a wired or wireless remote or through a wired or wireless computer whereby the spray delivery system has RF modulating receiving and sending transmission circuits and or logic and connectivity designed to accommodate said functions and whereby a wireless remote has an interface with an LCD panel that is made available with the logic to program the spray delivery system and to view said functions and to allow one to operate the said spray delivery system with all the functions of the aforesaid claims and whereby a computer is utilized with a wireless or a wired connection is made available with the software designed to program or view the programmed settings or to receive data such as cylinder content levels from one or more spray delivery systems matched to their unique identification codes where such spray delivery systems may be placed in the field, to track them, as mentioned in the aforementioned claims.
